(19) United States
(12) Patent Application Publication
(10) Pub. No.: US 2016/0268762 A1
(43) Pub. Date: Sep. 15, 2016

(54) FIBER COUPLING EFFICIENCY OF DIODE LASERS

(71) Applicant: BAE Systems Information and Electronic Systems Integration Inc., Nashua, NH (US)

(72) Inventors: Benjamin R. Johnson, Nottingham, NH (US); Daniel J. Creeden, Nashua, NH (US)

(21) Appl. No.: 14/649,587

(22) PCT Filed: Oct. 2, 2014
(86) PCT No.: PCT/US14/58770

§ 371 Date: Jun. 4, 2015

Related U.S. Application Data
(60) Provisional application No. 61/886,696, filed on Oct. 4, 2013.

(51) Int. Cl. H01S 3/0941; H01S 3/067; H01S 3/094

(52) U.S. Cl. CPC H01S 3/09415; H01S 3/094003; H01S 3/06733; H01S 3/0675; H01S 3/094007

(57) ABSTRACT

A system and method for increasing the fiber coupling efficiency of diode lasers is disclosed. The diode laser has a diode pump source for generating a force to pump a laser and a double clad fiber directly coupled to the diode pump source instead of coupling to the multimode fiber. The pumped laser is transmitted directly through the double clad fiber thereby increasing the coupling efficiency of the diode pump source. At least one connector is utilized for connecting the double clad fiber and the diode pump source. The connector has at least one adhesive placed in contact with an acrylate coating and not in contact with a glass cladding of the double clad fiber to avoid cladding stripper and fiber splice thereby increasing the fiber coupling efficiency.

### CROSS-REFERENCE TO RELATED APPLICATIONS

This Application claims rights under 35 USC §119(e) from U.S. Application Ser. No. 61/886,696 filed 4 Oct. 2013, the contents of which are incorporated herein by reference.

### TECHNICAL FIELD

The present disclosure relates generally to diode lasers. Embodiments of the disclosure are related to systems and methods of constructing diode lasers to increase the fiber coupling efficiency.

### BACKGROUND

High power laser diodes have become a staple pump source for both solid state and fiber optic lasers due to their high brightness, spectral versatility, environmental robustness and high efficiency. Typical high power fiber coupled diode lasers are focused into the large core of a glass-cladded multimode fiber.

FIG. 1 is an illustration of a schematic diagram of a prior art laser system 100 utilized for coupling a diode laser 102 to a double clad fiber 118 through a multimode fiber 116. The core multimode fiber 116 by which the diode laser 102, used to pump the double clad fiber laser, is coupled into is generally smaller than the glass cladding of the double clad fiber 118, it is pumping. This results in an aperture mismatch and a loss in efficiency because the double clad fiber 118 is capable of receiving lower brightness light than the multimode fiber 116 for comparable numerical apertures.

Thus, connecting the pump diode 102 to multimode fiber 116 a portion of the available laser power from the pump diode lost. Invariably power is launched into the cladding of multimode fiber 116. When multimode fiber 116 is built into a connector a cladding mode stripper is required to remove light coupled into the cladding of multimode fiber 116. Double clad fiber 118 typically provides a larger aperture to couple light from pump diode 102 to the fiber laser oscillator comprised of 118, 118*, 108, 110, 110* and associated splices 105 and 121. The larger aperture provided by double clad fiber 118 increases pump diode coupling efficiency and removes the necessity for a cladding stripper at the pump-diode to fiber connector interface. Higher diode-coupling efficiencies and a simplified laser construction process are realized when coupling light into double-clad fiber 118 compared to using muitimode fiber 116.

A result of higher diode coupling efficiencies is the removal of the cladding stripper built into the connector built into multimode fiber 116. For a laser system coupling pump diode 102 into double clad fiber 118 a cladding stripper is not needed at the diode to fiber interface as was the case when coupling into multimode fiber 116. Constructing the connector with double clad fiber 118 adhesive or other bonding materials must not come into contact with the bare glass of 118 so as to not unintentionally create a cladding stripper.

The highly reflective fiber Bragg grating 118* is fabricated from the same double clad fiber 118, For pump diode 102 coupled into multimode fiber 116 splice 104 is required to transmit the light coupled into multimode fiber 116 to the fiber laser comprised of 118, 118* 108, 110, 110* and associated splices 105 and 121. Splice 104 becomes unnecessary when coupling pump diode 102 into double clad fiber 118, The pump light is now coupled directly into the fiber laser comprised of 118, 118*, 108, 110, 110* and associated splices 105 and 121 without the need for an intermediate multimode fiber 116. The removing space 104 from the laser increases efficiency as all splices present some finite amount of loss (decrease in efficiency).

A need, therefore, exists for an improved coupling method that overcomes the above drawbacks.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

It is, therefore, one aim of the disclosed embodiments to provide for a diode laser comprising a diode pump source for generating a force to pump a laser and a double clad fiber directly coupled to the diode pump source instead of coupling to the muitimode fiber. The pumped laser is transmitted directly through the double clad fiber thereby increasing the coupling efficiency of the diode pump source.

It is, therefore, one aim of the disclosed embodiments to provide for a diode laser in which at least one connector for connecting the double clad fiber and the diode pump source.

It is, therefore, one aim of the disclosed embodiments to provide for a diode laser comprising the connector having at least one adhesive in contact with an acrylate coating of the double clad fiber.

It is, therefore, one aim of the disclosed embodiments to provide for a diode laser in which the adhesive is not in contact with a glass cladding of he double clad fiber and thus the adhesive does not act as a cladding stripper.

It is, therefore, one aim of the disclosed embodiments to provide for a fiber-coupled diode laser in which the double clad fiber comprises no cladding stripper and hence the need for thermal management system for the cladding strippers is avoided.

It is, therefore, one aim of the disclosed embodiments to provide for a fiber-coupled diode laser in which the double clad fiber may be the same fiber as the high-reflects fiber Bragg grating.

It is, therefore, one aim of the disclosed embodiments to provide for a fiber laser oscillator that comprises a fiber-coupled diode laser. The diode laser has a diode pump source for generating a force to pump a laser and a double clad fiber directly coupled to the diode pump source instead of coupling to the multimode fiber. The pumped laser is transmitted directly through the double clad fiber thereby increasing the coupling efficiency of the diode pump source. At least one connector is utilized for connecting the double clad fiber and the diode pump source. The connector comprises at least one adhesive in contact with an acrylate coating of the double clad fiber and not in contact with a glass cladding of the double clad. The double clad fiber comprises no cladding stripper and hence the need for thermal management system for the cladding strippers can be avoided. The double clad fiber may be the same as the high-reflector fiber Bragg grating.

It is, therefore, one aim of the disclosed embodiments to provide for a laser system that comprises a diode laser. The diode laser has a diode pump source for generating a force to pump a laser and a double clad fiber directly coupled to the diode pump source instead of coupling to the muitimode fiber. The pumped laser is transmitted directly through the double clad fiber thereby increasing the coupling efficiency of the diode pump source. At least one connector is utilized for connecting the double clad fiber and the diode pump source. The connector comprises at least one adhesive in contact with an acrylate coating of the double clad fiber and not in contact with a glass cladding of the double clad. The double clad fiber comprises no cladding stripper and hence the need for thermal management system for the cladding strippers can be avoided. The double clad fiber may be the same as the high-reflector fiber Bragg grating,

It is, therefore, one aim of the disclosed embodiments to provide for a method for constructing a double clad fiber connector. This method would include placing at least one adhesive in contact with an acrylate coating and avoiding at least one adhesive in contact with a glass cladding.

It is, therefore, yet another aim of the disclosed embodiments to provide for a method for constructing a double clad fiber connector comprising avoiding cladding strippers due to adhesive in contact with the glass cladding and avoiding thermal management system for the cladding strippers.

It is, therefore, one aim of the disclosed embodiments to provide for a method for constructing a double clad fiber comprising eliminating at least one fiber splice in the double clad fiber.

It is, therefore, one aim of the disclosed embodiments to provide for a method for eliminating a fiber splice when mating a fiber-coupled pump diode to a double-clad fiber laser.

It is, therefore, yet another aim of the disclosed embodiments to provide for a system and method for increasing the fiber coupling efficiency of diode lasers in which the environmental robustness of fiber coupled diode lasers is increased. Increasing the total usable aperture available for coupling of the diode laser mitigates damaging effects of beam degradation associated with high power operation and operation in strenuous environments, such as those on military platforms.

It is, therefore, yet another aim of the disclosed embodiments to provide for a system and method for increasing the fiber coupling efficiency of diode lasers which is more tolerant of beam blooming, diode smile, and beam wandering exhibited by diode lasers because there is a greater area available for fiber coupling.

### BRIEF DESCRIPTION OF TIDE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is an illustration of a schematic diagram of a prior art laser system comprising a diode pump coupled to a double clad fiber through a multimode fiber;

FIG. 2 is an illustration of a schematic diagram of a laser system comprising a diode pump directly coupled to a double clad fiber, in accordance with the disclosed embodiments;

FIG. 3 is an illustration of a configuration of a double clad fiber utilized in FIG. 2, in accordance with the disclosed embodiments and

FIG. 4 is an illustration of a flowchart showing a method of coupling diode pump and the double clad fiber of depicted in FIG. 3, in accordance with the disclosed embodiments.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

A system and method for increasing the fiber coupling efficiency of diode lasers is disclosed. The diode-fiber interface connector has at least one adhesive placed in contact with an acrylate coating and not in contact with a glass cladding of the double clad fiber to avoid creating a cladding stripper.

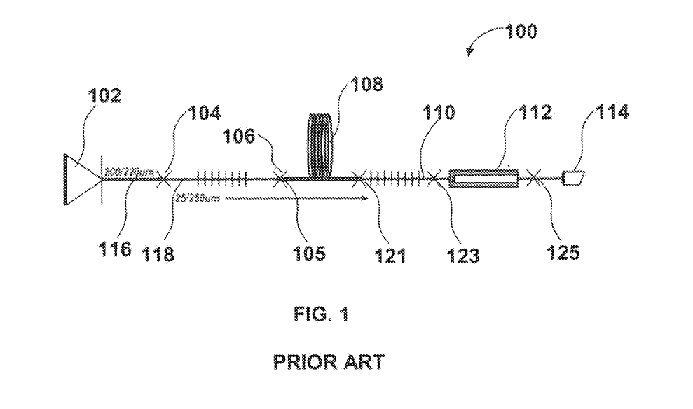

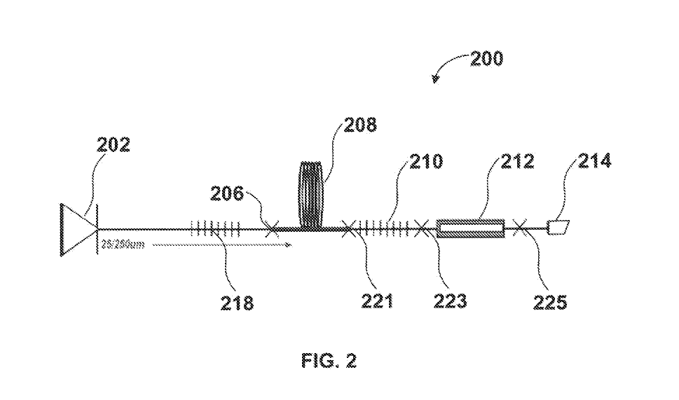

FIG. 2 is an illustration of a schematic diagram of a laser system 200 utilized for coupling a diode laser 202 directly to a double clad fiber 218 without connecting to a multimode fiber 116 as depicted in prior art system 100 of FIG. 1. The pumped laser is transmitted directly through the double clad fiber 218, thereby increasing the coupling efficiency of the diode laser 202. The diode laser 202 has at least one connector (not shown) for connecting the double clad fiber 218 and the diode laser 202. The connector comprises at least one adhesive in contact with an acrylate coating of the double clad fiber 218 and not in contact with a glass cladding of the double clad fiber 218. Adhesive in contact with an acrylate coating does not act as a cladding stripper and hence avoids the light loss. As there is no light loss hence there is no heat generation. Thus, the double clad fiber does not need a thermal management system for the cladding strippers.

As shown in FIG. 2, for example, coupling the highly reflective double clad fiber 218 with a REDF 208 and coupling the REDF 208 with partial reflective double-clad fiber 210 results in spaces 206 and 221 respectively. Coupling partial reflective double-clad fiber 210 to a terminator 214 results in the splices 223 and 225 and a cladding stripper 212.

It should be noted, in prior art system 100 depicted in FIG. 1, the multimode fibers 116 unnecessarily choke the total power potentially coupled into double clad fiber laser. The system 200 increases the coupling efficiency of the diode laser 202 into a fiber by eliminating the multimode fiber 116 depicted in FIG. 1 and using a double clad fiber 218 in its place. The system 200 enables more power to be transported to the pumped laser medium without significant sacrifice in brightness or alteration of existing design. Additionally, the system 200 simplifies the use of fiber coupled diode laser 202 by removing the cladding mode stripper responsible for removing the light coupled into the glass cladding of a multimode fiber. This cladding mode stripper is a heat source and requires some form of thermal dissipation via air or water. The system 200, by leveraging the ability of a double clad fiber 218 to propagate light in the polymer clad glass cladding, eliminates the need to design and engineer a thermal management system for these cladding mode strippers, thus greatly simplifying laser architecture.

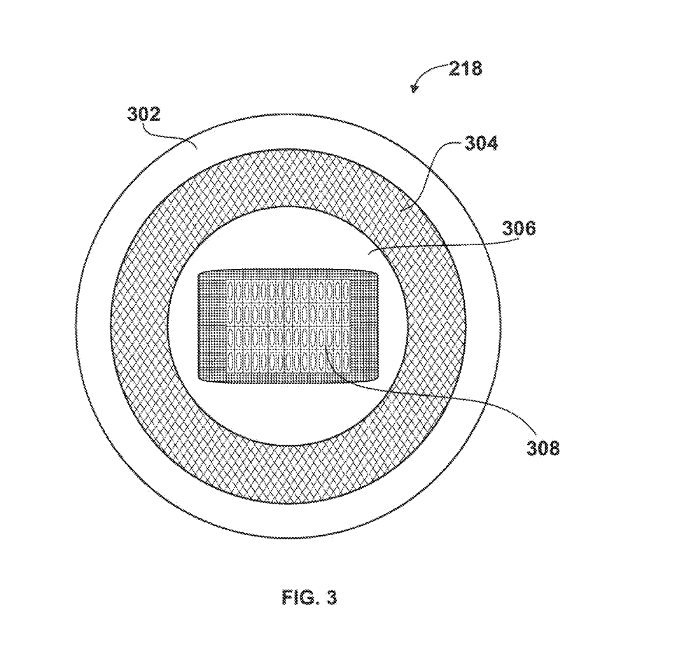

FIG. 3 is an illustration of a configuration of a double clad fiber 218 utilized in FIG. 2, in accordance with the disclosed embodiments. When the diode laser 202 and double clad fiber 218 are bonded with connectors, the adhesive is placed directly on the acrylate coating 304 and not on the glass cladding 306 to bond the fiber to the ferrule 302, which holds the fiber 218. The glass cladding 306 of the fiber 218 carries the laser pumped from the diode laser 202. Numeral 308 in FIG. 3 is an arbitrary pattern intended to represent the diode light being coupled into the cladding of the double-clad fiber. Directly connecting the double clad fiber 218 with the diode laser 202 increases environmental robustness and also increases the total usable aperture available for coupling of the diode laser 202. This method mitigates damaging effects of beam degradation associated with high power operation and operation in strenuous environments, such as those on military platforms.

The system 200 is more tolerant of beam blooming, diode smile, and beam wandering exhibited by diode laser 202 because there is a greater area available for fiber coupling. This is a very critical attribute for high reliability lasers, particularly in demanding applications where regular maintenance or repair is not an option, like on a satellite of a military platform actively deployed.

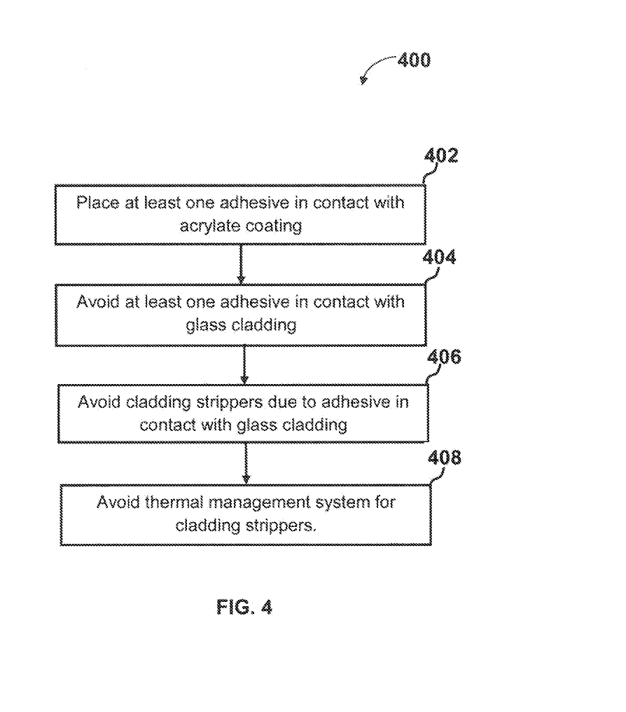

in FIG. 4 a method 400 of coupling a diode laser 202 and the double clad fiber 218 of depicted in FIG. 3. As said at the block 402 and 404, the adhesive for connecting diode laser and the double clad fiber is placed on the acrylate coating on the fiber and not in contact with glass cladding. As depicted at blocks 406 and 408, adhesive in contact with acrylate coating avoids cladding strippers created by adhesive in contact with glass cladding and thermal management system for the cladding strippers. This increase the coupling efficiency of the laser diode.

It should be noted that there is also a significant simplification in fiber laser architecture associated with the present system. The system, when implemented in a fiber laser oscillator, eliminates a splice in the fiber laser by allowing the diode light to be directly coupled into the double clad fiber that the high-reflector fiber Bragg grating is written into. For a company producing large numbers of these lasers, this has several implications such as eliminating a splice decreases assembly time by an amount proportional to the total number of splices needed to build the laser, laser reliability increases by eliminating that splice, and laser efficiency is increased by eliminating a potential source for loss and increased the coupling efficiency of the laser diode. Furthermore, packaging of such a laser is simplified since the design does not need to consider the placement and protection of an additional critical element in the laser architecture.

Finally, in the system, a diode-fiber interface cladding stripper is unnecessary and unwanted. In addition, the construction of the fiber connector must change to ensure it survives. This requires the connector be made such that no optical adhesives are in contact with the glass cladding. Any optical adhesive in contact with the glass cladding would act as a cladding stripper and remove the diode light. This could also result in heating of the connector which could lead to catastrophic optical damage. To eliminate this effect when making the connector, any optical adhesive must be placed in contact with the acrylate coating only, rather than the bare glass. By adhering to the acrylate, no out-coupling of cladding light can occur, as the waveguide interface (the acrylate-cladding interface) is in-tact. This enables the coupling of diode light into the double clad fiber while ensuring the connector adhesive does not act as a cladding stripper.

While the present invention has been described in connection with the preferred embodiments of the various Figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

it will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

What is claimed is:

1. A diode laser comprising:
a diode pump source for generating a force to pump a laser; and
a double clad fiber directly coupled to the diode pump source instead of coupling to the multimode fiber, wherein the pumped laser is transmitted directly through the double clad fiber, thereby increasing the coupling efficiency of the diode pump source.

2. The diode laser of claim 1 further comprises at least one connector for connecting the double clad fiber and the diode pump source.

3. The diode laser of claim 2, wherein the connector comprises at least one adhesive in contact with an acrylate coating of the double clad fiber.

4. The diode laser of claim 3, wherein the adhesive is not in contact with a glass cladding of the double clad fiber.

5. The diode laser of claim 3, wherein the adhesive does not act as a cladding stripper.

6. The diode laser of claim 1, wherein the double clad fiber comprises no cladding stripper.

7. The diode laser of claim 1, wherein the double clad fiber comprises no then mal management system for the cladding strippers.

B. The diode laser of claim 1, wherein the double clad fiber comprises high-reflector fiber Bragg grating.

9. A fiber laser oscillator comprising a diode laser, therein the diode laser comprises:
a diode pump source for generating a force to pump a laser; and
a double clad fiber directly coupled to the diode pump source instead of coupling to the multimode fiber, wherein the pumped laser is transmitted through the double clad fiber, thereby increasing the coupling efficiency of the diode pump source.

10. The fiber laser oscillator of claim 9, wherein the double clad fiber comprises high-reflector fiber Bragg grating.

11. A laser system comprising a diode laser, wherein the diode laser comprises:
a diode pump source for generating a force to pump a laser; and
a double clad fiber directly coupled to the diode pump source instead of coupling to the multimode fiber, wherein the pumped laser is transmitted through the double clad fiber, thereby increasing the coupling efficiency of the diode pump source.

12. A method for constructing a double clad fiber comprising:
placing at least one adhesive in contact with an acrylate coating; and
avoiding at least one adhesive in contact with a glass cladding.

13. The method of claim 12 further comprising:
avoiding cladding strippers due to adhesive in contact with the glass cladding; and
avoiding thermal management system for the cladding strippers.

14. The method of claim 12 further comprising eliminating at least one fiber splice in the double clad fiber.

15. A method for eliminating a fiber splice in a pump diode comprising:
placing at least one adhesive in contact with an acrylate coating; and
coupling a double clad fiber directly to the pump diode.

18. The method of claim 15 further comprising:
avoiding at least one adhesive in contact with glass cladding;
avoiding cladding strippers by placing adhesive in contact with the glass cladding; and
avoiding thermal management system for the cladding strippers.
